(19) United States
(12) Patent Application Publication
(10) Pub. No.: US 2010/0327594 A1
(43) Pub. Date: Dec. 30, 2010

(54) COMPLEX OCEAN POWER SYSTEM COMBINING SLUICE POWER AND OCEAN CURRENT POWER

(76) Inventors: Kyung Soo Jang, Seoul (KR); Jung Eun Lee, Seoul (KR); Jae Won Jang, Seoul (KR); Seung Won Jang, Seoul (KR)

Correspondence Address: BIRCH STEWART KOLASCH & BIRCH, PO BOX 747, FALLS CHURCH, VA, 22040-0747, US

(21) Appl. No.: 12/864,652

(22) PCT Filed: Apr. 29, 2008
(86) PCT No.: PCT/KR08/02414

§ 371 Date: Jul. 26, 2010

(30) Foreign Application Priority Data
Mar. 25, 2008 (KR) 10-2008-0027182

(51) Int. Cl. F03B 13/08; F03B 13/26

(52) U.S. Cl. 290/53

(57) ABSTRACT

There is provided with a complex ocean power system combining ocean current power generation for generating electricity by forming a plurality of ocean current generators in front and rear of sluice structures of tidal power dams and sluice power generation for generating electricity by forming a plurality of ocean current generators in sluice conduits of the sluice structures, comprising: constructing barrages, which cross over the sea, to make up a lake; installing sluice structures of tidal power dams between the barrages 10 to generate electricity by changing a potential energy difference between seawaters caused by tides and ebbs to kinetic energy; installing ocean current generators in front and rear of the sluice structures and in the sluice conduits of the sluice structures to generate electricity by rotating turbine blades using the flow of the incoming seawater from a sea side into a lake side during flood tide and the flow of the seawater discharged from the lake side into the sea side during ebb tide; and installing sluice gates in the sluice structures 102, 210 to close and open the sluice conduits during flood tide and ebb tide.

### TECHNICAL FIELD

The present invention relates to a complex ocean power system combining sluice power generation and ocean current power generation, and more particularly, to a complex ocean power system combining sluice power generation and ocean current power generation which is capable of increasing an operating rate of ocean current generators and efficiently generating electrical power energy by using the incoming seawater into a lake through sluice conduits of sluice structures connected with barrages, which cross over the lake and the sea, or a fast flow of seawater discharged to the sea. In particular, the present invention adopts a system for generating power using ocean current, which flows with a fast speed through the sluice structures to change a potential energy difference between seawaters, which is generated in front and rear of the barrage by tides and ebbs, to kinetic energy.

### BACKGROUND ART

The present invention relates to tidal power generation and ocean current power generation among ocean energy resources. The west and south coast lines in Korea have a high difference between tides and ebbs and are formed of a rias coast, and thus, were well known as promising regions for the development of world ocean energies where many ocean energies such as tidal power generation and tidal current generation exist. With respect to a lake formed by a gap between islands and a recovery projection or reclamation of coast lines, such as Sihwa lake, Garorim bay, Saemangeum and Incheon bay, a water level of the outside sea centering around barrages changes by several meters up and down depending on a period of tides and ebbs, whereas the water level of the lake (lagoon) must be kept under the managing level.

In generally, tidal power generation is a method of generating electricity by using a potential energy difference existing between seawaters, which move due to tides, and may be divided into: a single lagoon and multi lagoons depending on the number of lakes or lagoons; and a single flow type and a double flow type depending on the direction of flow, and the single flow type into a flooding type and an ebbing type depending on tides to be used when generating electricity. Further, a turbine generator for tidal power generation may be divided into a bulb turbine, a tubular turbine and a rim turbine according to the type thereof.

The tidal power plant on construction in Sihwa lake, west coast line in south Korea keeps the water level of the outside sea high and the water level of the lake side low when generating electricity and adapts a flooding type generation method to generate electricity only in the case of flood tide and the bulb turbine.

Until recently, the tidal power system is characterized by constructing barrages that cross over the sea and installing turbine structures of a tidal power plant and sluice structures of a tidal power dam for generating electricity using a difference in potential energy between seawaters by tides and ebbs, and turbine generators to generate electricity by rotating turbine blades using the flow of incoming seawater by a difference in water head of seawater being installed in the turbine structures, and sluice gates for closing at tides and opening at ebbs the sluice conduits being installed in the sluice structures.

The power output obtainable from the tidal power system is proportional to the efficiency of a turbine generator, the cross sectional area of a seawater passage and 3/2 power of the difference between sea levels of the sea and the lake caused by tides and ebbs, and therefore, a highly efficient turbine generator, a generator having large blades, and large difference between sea levels by tides and ebbs result in high economical efficiency.

Along with tidal power generation, wave power generation and thermal difference generation, tidal current power generation is another generating method of closing to the commercialization among ocean energy resources and producing electricity from kinetic energy of tidal current by installing turbine generators in the place where tidal current is flowing fast. The tidal current power generation using tidal current is involved in ocean current power generation in terms of broad meaning. (hereinafter referred to “tidal current power generation” or “tidal current” as “ocean current power generation” or “ocean current”)

In general, turbine generators having far lower RPM at rated load than turbine generators used for tidal power generation are used for ocean current power generation and are classified into: Helical type, HAT (Horizontal Axis Turbine) type and VAT (Vertical Axis and Turbine) type depending on the type of turbine generators; and floating type and attaching type to bottom depending on installation methods of turbine generators.

The tidal power generation artificially forms barrages and generates electricity by driving turbine generators for tidal power generation using the head drop of seawater in the inner side and outer side of the barrages. However, the ocean current power generation generates electricity by installing the ocean current generators for ocean current power generation in a corner of ocean currents, which naturally flow. The theoretical principles of ocean current power generation is similar to that of wind power generation but is different from the wind power generation to rotate turbines by using ocean currents, which flow on, instead of the wind. In case of the ocean current power generation, the density of power/area thereof is larger about 4 times than that of wind power because the density of seawater is larger about 840 times compared with the density of air. Thus, in the case of same facilities capacity, the size of an ocean current generator is far smaller compared with that of a wind power generator.

The power output obtainable from ocean current power generation is proportional to the efficiency of an ocean current generator, the cross sectional area of an ocean current passage and the 3rd power of the ocean current velocity. Therefore, the high velocity of ocean current is absolutely advantageous for ocean current power generation.

Tidal power and ocean current energies have advantages in that: the energies are infinite, clean energy originating from the universal gravitation among the sun, the moon, and the earth which continues as long as the solar system exists; the energies are not affected by weather or season due to the periodicity of the flowing and ebbing tides; long-term prediction of generation output is possible; it is possible to supply power continuously for a certain period of time; and it is easy to connect within a power network. On the other hand, its disadvantages include sporadic generation and large initial investment due to the construction of power transmission lines if the power plant is far from land.

Until recently, the applicability of ocean current power generation was considered if the average speed of ocean current was fast, i.e., typically at least 2.0 m/s in the high current cycle, in narrow straits between islands and land. However, while several tidal power plants have been practically applied, one example of large-scale ocean current power generation is rare in the world. The reason for this is that it was not easy to find a proper site on which to install turbine generators due to the lack of natural sea areas where the seawater flow is fast enough for ocean current power generation. Furthermore, even if the average speed of ocean current were satisfactory, it is difficult to achieve a structural stability of the turbine generators and reliable control of generation volume if the speed distribution is uneven according to the seabed topography of the area where an ocean current power plant is to be installed.

In general, the average velocity of natural ocean currents for ocean current power generation must be 2.0 to 2.5 m/s, which is greatly affected by seabed topography and the frequent change of flow direction. However, ocean currents that can be obtained from a tidal power plant include more even kinetic energy, which has higher utility value than the natural ocean current condition. It was reported for the case of the Sihwa Lake Tidal Power Plant, which adopts a single flow flooding type that when it generates electricity with the head drop of 6.0 m at flood tide, the average velocity of the seawater discharged to the lake after passing through turbine generators of the tidal power plant is at least 3.0 m/s and when it discharges the seawater with the head drop of 1.9 m/s at ebb tide the average velocity of the seawater discharged to the sea through sluice conduits is at least 6.0 m/s.

Accordingly, the complex ocean power system combining sluice power generation formed of the sluice structures of the tidal power dam and ocean current power generation according to the present invention is characterized by sluice power generation for generating electricity by installing the ocean current generators for ocean current power generation, which are proportional to the 3rd power of the ocean current velocity, instead of the turbine generators for turbine structures of the existing tidal power plant in the sluice conduits of the sluice structures of the tidal power dam and ocean current power generation for generating electricity by forming ocean current power parks in front and rear of the sluice structures of the tidal power dam.

### DISCLOSURE OF INVENTION

### Technical Problem

In contrast to the existing ocean current power system, which uses a natural flow of seawater caused by tides and ebbs, or the existing tidal power system, which generates electricity using a difference in potential energy between seawaters caused by tides and ebbs, the seawater, which passes through sluice structures of a tidal power dam and sluice conduits, is high-quality seawater, which flows in a fixed direction at a predictable speed, compared with natural seawater, thereby easily controlling power generation volume, and a high speed unobtainable from a condition of nature could be obtained, thereby resulting in high generating volumes and high economic effects.

Accordingly, in consideration of the above circumstances, the present invention has been made and an object of the present invention is to provide a complex ocean power system combining sluice power generation and ocean current power generation, which is capable of increasing an operating rate of turbine generators and efficiently generating electrical energy by forming a tidal power dam formed of a plurality of sluice structures in the middle of barrages across the sea and the lake and using incoming seawater into the lake through the sluice conduits of the tidal power dam and the fast flow of the seawater discharged from the lake to the sea.

A further object of the present invention is to provide a complex ocean power system combing sluice power generation and ocean current power generation, which is capable of increasing an operating rate of a complex ocean power system by using a fast flow of the incoming seawater into the lake through sluice structures and sluice conduits, and of the seawater discharged to the sea by installing bi-directional ocean current generators for generating electricity in ocean currents, which flow in the opposite direction each other during flood tide and ebb tide, and capable of producing high electric power by ocean current generators because the seawater, which passes through the sluice structures and the sluice conduits, has kinetic energy having higher value in use and uniformity than natural seawater.

An object of the present invention is to provide a complex ocean power system combing sluice power generation and ocean current power generation, which is capable of easily controlling a power generation volume by providing the seawater, which passes through sluice structures of a tidal power dam and the sluice conduits, which is high-quality seawater, which flows in a fixed direction at a predictable speed, compared with natural seawater, and which is capable of minimizing vortex and resistance caused by a sudden reduction in the width of a waterway by forming the sluice conduits in the sluice structures of the present invention to change the potential energy difference between seawaters in the sea side and the lake side to kinetic energy in a culvert type in that half-spherical surface part (R) is formed in a sea side and a lake side, in consideration of economic efficiency, constructability, maintainability and manageability.

An object of the present invention is to provide a complex ocean power system combing sluice power generation and ocean current power generation, which is capable of producing much electric power by forming barrages in an elliptical shape or a curved shape, and thus, increasing the flow volume and speed of ocean currents, which approach the tidal power dam.

An object of the present invention is to provide a complex ocean power system combing sluice power generation and ocean current power generation, which is capable of generating electricity with high operating rate because the sluice conduits in the sluice structures of the present invention can obtain a high ocean current speed of about 6.2 m/s (=\sqrt{2αΔh}) even when a difference in water head between seawaters in the sea side and lake side is 2.0 m or below, unlike the conventional tidal power system, which is not able to generate electricity because the turbine generators in the turbine structures of a tidal power plant are not driven when a difference in water head between seawaters in the sea side and lake side is 2.0 m or below, thereby resulting in high economic benefits with very low construction costs.

### Technical Solution

To accomplish the above objects, the present invention is characterized by: constructing barrages across the sea to make up a lake; installing a plurality of sluice structures between the barrages to generate electricity by changing a potential energy difference of seawaters caused by tides and ebbs to kinetic energy; installing ocean current generators in front and rear of the sluice structures and in the inside of the sluice conduits of the sluice structures to generate electricity by rotating turbine blades using the flow of the incoming seawater from a sea side to a lake side during flood tide and the flow of seawater discharged from the lake side to the sea side during ebb tide; installing sluice gates in the sluice conduits of the sluice structures to close and open the sluice conduits during flood tide and ebb tide; forming an ocean current power park in the lake side by installing a plurality of ocean current generators in the lake side of the sluice structures to generate electricity using a flow of the incoming seawater from the sea side to the lake side through the sluice conduits; forming an ocean current power park in the sea side by installing a plurality of ocean current generators in the sea side of the sluice structures to generate electricity using the fast flow of the seawater discharged from the lake side to the sea side through the sluice conduits; and installing a plurality of ocean current generators in the inside of the sluice conduits in the sluice structures to generate electricity using the flow of the seawater, which moves from the sea side to the lake, and from the lake side to the sea side.

A plurality of ocean current generators installed in the front sea side and the rear lake side of the sluice structures are arranged in a cross shape having a predetermined space between lines thereof so that even number lines and odd number lines thereof cross each other.

The plurality of ocean current generators installed in the front lake side of the rear lake side of the sluice structures are installed on a mono file inserted into the seabed, respectively.

The sluice structures are connected to each other by putting connection structures or connection barrages therebetween.

The connection structures or connection barrages are formed in an elliptical shape to induce the flow of seawater into the ocean current power parks and make the speed of ocean currents fast. Further, they are formed so that a distribution of the speed is uniformly induced, and thus, ocean current power generation is profitably performed.

It is characterized in that at least one or more sluice structures are connected.

The ocean current generators installed in the complex ocean power system according to the present invention have a structure or function capable of generating electricity even when the direction of ocean current is changed.

### EFFECTS OF THE INVENTION

A complex ocean power system combining sluice power generation and ocean current power generation according to the present invention may maximize an operating rate of power facilities by using the incoming seawater into the lake and the fast flow of the seawater discharged into the sea through sluice conduits of sluice structures and installing bi-directional ocean current generators for generating electricity in ocean current, which flows in the opposite direction each other during flood tide and ebb tide. At this time, the ocean current that passes through the sluice conduits of the sluice structures according to the present invention is capable of producing high electric power by ocean current generators because the seawater, which passes the sluice structures and the sluice conduits, has kinetic energy having higher value in use and uniformity than natural seawater.

Further, the ocean current generators for ocean current power generation, which are far more simple than the huge and complex turbine generators for tidal power generation to be used in the turbine structures of a tidal power plant for the existing tidal power system, are installed in the sluice conduits of the tidal power dam of the tidal power system, for sluice power generation, thereby performing bidirectional power generation during flood tide and ebb tide. Thus, it is not needed to construct the turbine structures of the existing tidal power plants, and thus, construction costs can be largely reduced.

First of all, the present invention brings about the possibility of the development and production of ocean current generators for ocean current power generation based on only domestic technologies, in replacement of the development of the turbine generator for tidal power generation, which has been regarded as a technology barrier, inspires a motivation for mass production of necessary ocean current generators along with the exploitation of new domestic markets, and provides with opportunities capable of occupying in advance technologies and markets in the fields of the world's ocean current power generation and sluice power generation, which are in the step of verification to be truly commercialized.

### BRIEF DESCRIPTION OF DRAWINGS

The accompanying drawings illustrate example embodiments of the present invention. Example embodiments may, however, be embodied in different forms and should not be considered as limited to the embodiments set forth in the drawings.

FIG. 1 is a plane view illustrating a complex ocean power system combining sluice power generation and ocean current power generation according to an embodiment of the present invention that two kinds of sluice structures of a tidal power dam in which a length of sluice conduits thereof is different are connected with a middle connection structures; and

FIG. 2 is a side view illustrating sluice conduits in sluice structures of a tidal power dam and ocean current generators in a sea side and a lake side according to an embodiment of the present invention taken along a line A-A in FIG. 1.

### BEST MODE FOR CARRYING OUT THE INVENTION

Hereinafter, embodiments of the present invention will now be described in greater detail with reference to the accompanying drawings.

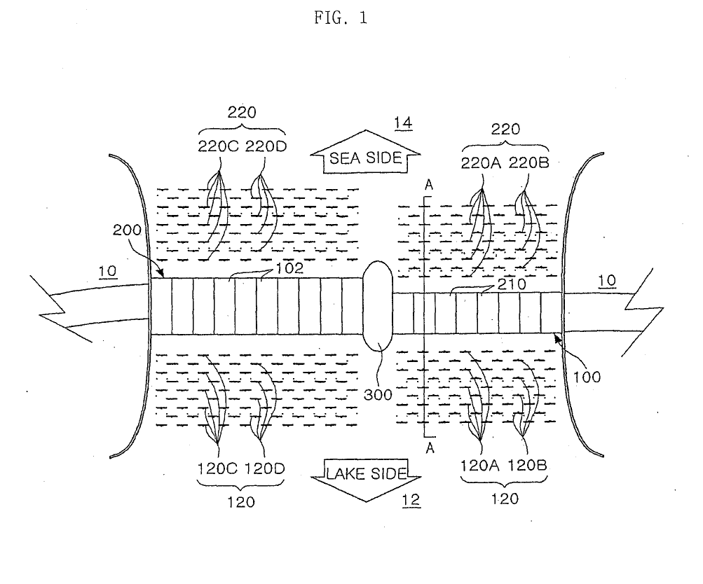

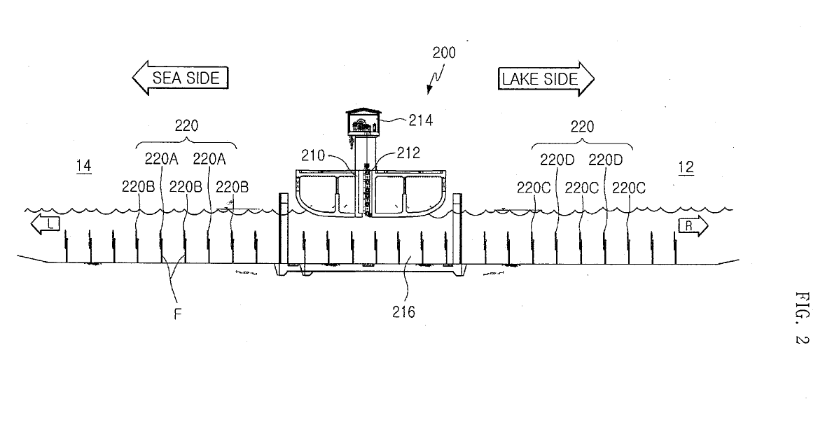

FIG. 1 is a plane view illustrating a complex ocean power system combining sluice power generation and ocean current power generation according to an embodiment of the present invention that two kinds of sluice structures of a tidal power dam in which a length of sluice conduits is different are connected with a middle connection structures; and FIG. 2 is a side view illustrating sluice conduits in sluice structures of a tidal power dam and ocean current generators in a sea side and a lake side according to an embodiment of the present invention taken along a line A-A in FIG. 1.

As illustrated in FIG. 1, the complex ocean power system combining sluice power generation and ocean current power generation according to the present invention needs to construct barrages 10 in the place where a large difference between tides and ebbs occurs. Preferably, the barrages 10 are formed in an elliptical shape or a curved shape to induce seawater, which approaches a tidal power dam, into ocean current power generation.

After the barrages 10 as described above are constructed, a lake 12 is formed as shown in FIG. 1. In the middle of the barrages 10, a plurality of the tidal power dams 100, 200 having each different size, which block a lake side 12 and a sea side 14, are installed.

Preferably, the tidal power dams 100, 200 are connected to each other by putting a connection structure 300 or a connection barrage therebetween. The connection structure 300 or the connection barrage can be established with hundreds or thousands of meters according to characteristics of topography.

As illustrated in FIG. 2, sluice gates 212 are installed within sluice structures 210, which form the tidal power dam 200. The sluice gates 212 lowed by the lifting devices 14 at need play a role to block that seawater in the sea side 14 flows into a lake side 12 or that seawater in the lake 12 is discharged into the sea side 14.

The sluice structures 102, which form the tidal power dam 100, are illustrated as ten sluice structures 102 in one unit body as shown in FIG. 1 and the sluice structures 210, which form the tidal power dam 200, are illustrated as eight sluice structures in one unit body as shown in FIG. 1. However, it is not limited to that and the installation number thereof may be modified according to topography characteristics or tides and ebbs, and a plan of generation volume.

A plurality of ocean current generators 220, which generate electricity using the flow of the seawater discharged through the sluice gates 212 into the sea, are installed in the front direction of the sluice structures 102, 210, namely, in the sea side 14 as illustrated in FIGS. 1 and 2, thereby forming an ocean current power park in the sea side 14.

The plurality of ocean current generators 220 are arranged in cross shape with a predetermined space between lines as much as the diameter of turbine blades of the ocean current generators and the ocean current generators 220A, 220C in odd number lines and the ocean current generators 220B, 220D in even number lines are arranged to be cross each other.

Moreover, when the ocean current generators 220 are arranged, an installation number of the ocean current generators to a unit area may be increased by most suitably setting arrangement spaces in a perpendicular direction to the flow direction of seawater according to the speed of ocean current. In particular, as conditions of the present invention, in the case that the speed of ocean current discharged through the sluice conduits 216 is very high and the flow of seawater is good, preferably, the ocean current generators may be most suitably arranged by a numerical calculation using a computational fluid dynamic commercial program.

At here, each of the ocean current generators 120 in the lake side, the ocean current generators 220 in the sea side and the ocean current generators in the sluice conduits is supported by and installed at a monofile (F) inserted into the seabed, respectively.

Moreover, each of the ocean current generators 120 in the lake side 12, the ocean current generators 220 in the sea side 14 and the ocean current generators in the sluice conduits includes a propeller, which is rotated and driven by the flow of ocean current, and a generator having a rotor connected to a rotational axis of the propeller, respectively. The propeller and the generator can also generate electricity by seawater, which flows in the opposite direction.

At least one or more the sluice structures 102 of the tidal power dam 100 and the sluice structures 210 of the tidal power dam 200 are connected, respectively, as shown in FIG. 1.

In the example embodiment, when the ocean current power park is formed through the ocean current generators 120, 220 according to topography characteristics or a plan of generation volume of the tidal power dam 100 and the tidal power dam 200, a complex ocean power system combining sluice power generation and ocean current power generation may be formed by: installing a plurality of ocean current generators in sluice conduits of sluice structures 102, 210 of tidal power dams 100, 200; installing a plurality of ocean current generators 120 only in a lake side 12 of the tidal power dams 100, 200; installing the plurality of ocean current generators 220 only in a sea side 14 of the tidal power dams 100, 200; and installing a plurality of ocean current generators 120, 220 in all of the lake side 12 and the sea side 14 of the tidal power dams 100, 200, respectively as shown in FIG. 1.

The effects of the example embodiment as described above will be explained.

When head drop caused by the difference between water levels of seawater in the sea side 14 and the lake side 12 is small, the sluice gates installed in the sluice structures 102, 210 of the tidal power dam 100, 200 block the sluice conduits, and when head drop caused by a difference between water levels of seawater in the sea side 14 and the lake side 12 becomes a predetermined standard, the sluice gates are lifted up. Therefore, the seawater in the sea side 14 flows into the lake side 12 through the sluice structures 102, 210 to the arrow direction L as shown in FIG. 2. At this time, the more the seawater approaches the tidal power dam 100, 200 in the sea side 14, the faster the speed of the seawater thereof becomes. And the seawater is discharged with fast speed into the lake side through the sluice structures 102, 210. The ocean current, which passes through the sluice structures 102, 210, develops into turbulent ocean current having excellent current characteristics profitable for ocean current power generation while passing the long sluice conduits having a square cross-section, and thus, flows into the ocean current generators 120 in the rear direction of the tidal power dams 100, 200.

Accordingly, the blades of the ocean current generators installed in the ocean current power parks 120, 220 installed in front and rear of the sluice structures 102, 210 of the tidal power dam 100, 200 and in the sluice conduits of the sluice structures are rotated and produce electric power by the flow of the seawater. At this time, when a difference between water levels of the seawater is 2.0 m, the average speed of the incoming seawater to the lake side 12 through the sluice structures 102, 210 becomes 6.0 m/s or more. Accordingly, ocean current power generation is accomplished from the plurality of ocean current generators 120 arranged by the optimization of computer simulation. The ocean current power generation is continued until the water level of the lake reaches the managing level and the ocean current generators 110 of the tidal power plant 100 stop to generate electricity when the water level of the lake reaches the managing level and this stop state is kept until the water level of the sea side becomes lower than that of the lake side at ebb tide.

To make preparations for seawater, which will flow in the opposite direction during ebb tide, the blades of the entire ocean current generators during the stop state are set in the opposite direction.

Meanwhile, when the water level of the sea side 14 becomes lower than that of the lake side 12 by ebb tide after flood tide, the sluice gates in the sluice structures 102, 210 of the tidal power dam 100, 200 are opened as shown in FIG. 2 and the seawater in the lake side 12 is discharged to the sea side 14 as the arrow direction (L) through the sluice conduits 216.

At this time, an average speed of the seawater discharged through the sluice gates 212 is 6.0 m/s or more and the plurality of ocean current generators 220, which are installed in the sea side 14, are driven by the flow which goes through the tidal power dam 100, 200, thereby producing electricity.

The complex ocean power system combining sluice power generation and ocean current power generation according to the present invention generates electricity by using the flow of the incoming seawater into the lake side 12 from the sea side 14 and the seawater discharged to the sea side 14 from the lake side 12, and therefore, is more excellent than the SIHWA Lake tidal power generation in a single flow flooding type, which generates electricity only when seawater flows into the lake side from the sea side, in respect to the operating rate of power facilities.

To transmit electricity from the ocean current generators 120 in the lake side and the ocean current generators 220 in the sea side to a substation, the electricity may be transmitted to a substation within the tidal power dams 100, 200 through cables under the sea or may be transmitted directly to a substation on land.

The complex ocean power system combing sluice power generation and ocean current power generation according to the present invention is able to generate electricity during either flood tide or ebb tide and maximize the operating rate of power generation facilities because it generates electricity using bidirectional flow of seawater.

Further, the seawater, which passes through sluice structures 102, 210 of the tidal power dams 100, 200, according to the present invention, has much value in use than the seawater obtainable from natural tidal currents, and thus, electric power can be efficiently produced by the ocean current generators 120 in the sea side and the ocean current generators 220 in the sea side, and the seawater has a good impact on the durability of the ocean current generators. That is, the seawater, which passes through the sluice structures 102, 210 of the tidal power dams 100, 200, is high-quality seawater, which flows in a fixed direction at a predictable speed and makes the adjustment of power generation volume easy, and thus, costs required for constructing tidal power plants can be reduced and power generation volumes can be maximized, thereby resulting in high economic effects.

In general, to preserve and manage the ocean current generators, the ocean current generators and subsidiary facilities thereof are pulled up to the sea, and may close by a little ship, while the complex ocean current power system according to the present invention has advantages such that diving or ROV (Remotely Operated Vehicles) may be used for preserving and managing the ocean current generators because flow conditions of ocean current become more gentle than that of a tidal current power plant using the flow of natural tidal currents, due to the existence of barrages which are constructed at the time of tidal power generation, in the case that generation does not occur or the seawater is not discharged.

The present invention has been described above in relation to several example embodiments shown in the drawings, but should not be considered as limited to the embodiments. Rather, those skilled in the art will recognize that various changes in the details of these embodiments can be made without departing from the scope of the invention.

1-11. (canceled)

12. A complex ocean power system combining sluice power generation and ocean current power generation, comprising:
constructing barrages, which cross over the sea, to make up a lake installing sluice structures of tidal power dams between the barrages to generate electricity by changing a potential energy difference between seawaters caused by tides and ebbs to kinetic energy;
installing ocean current generators for sluice power generation in the sluice structures to generate electricity using the flow of seawater;
installing sluice gates in the sluice structures to close and open sluice conduits during flood tide and ebb tide; and
forming an ocean current power park in the lake side by installing a plurality of ocean current generators in a rear lake side of the sluice structures of the tidal power dams to generate electricity using the flow of the seawater discharged into the lake side through the sluice structures.

13. The complex ocean power system according to claim 12, wherein the plurality of ocean current generators installed in the rear lake side of the sluice structures of the tidal power dams are arranged in a cross shape with a predetermined space between lines and the ocean current generators in even number line and odd number line are arranged to be cross each other.

14. The complex ocean power system according to claim 12, wherein the plurality of ocean current generators installed in the rear lake side of the turbine structures of the tidal power dams are installed at a monofile inserted into the sea bed, respectively.

15. The complex ocean power system according to claim 12, wherein the sluice structures of the tidal power dams are connected to each other by putting a connection structure therebetween.

16. The complex ocean power system according to claim 12, wherein at least one or more sluice structures of the tidal power dams are connected to each other, respectively.

17. The complex ocean power system according to claim 12, wherein the barrages have an elliptical shape or a curved shape to induce seawater in the ocean current power generation parks.

18. The complex ocean power system according to claim 12, wherein the ocean current generators installed in the complex ocean power system have a structure or function, which is able to generate electricity even when the direction of ocean current is changed.

19. A complex ocean power system combining sluice power generation and ocean current power generation, comprising:
constructing barrages, which cross over the sea, to make up a lake;
installing sluice structures of tidal power dams between the barrages to generate electricity by changing a potential energy difference between seawaters caused by tides and ebbs to kinetic energy;
installing ocean current generators in the sluice structures to generate electricity by rotating turbine blades using the flow of the incoming seawater into sluice conduits during flood tide and ebb tide;
installing sluice gates in the sluice structures to close and open the sluice conduits during flood tide and ebb tide; and
forming an ocean current power park in a sea side by installing a plurality of ocean current generators in the front sea side of the sluice structures of the tidal power dams to generate electricity using the flow of the seawater discharged into the sea side through the sluice conduits.

20. The complex ocean power system according to claim 19, wherein the plurality of ocean current generators installed in the front sea side of the sluice structures of the tidal power dams are arranged in cross shape with a predetermined space between lines and the ocean current generators in even number line and odd number line are arranged to be cross each other.

21. The complex ocean power system according to claim 19, wherein the plurality of ocean current generators installed in the front sea side of the sluice structures of the tidal power dam are installed at a monofile inserted into the sea bed, respectively.

22. The complex ocean power system according to claim 19, wherein the sluice structures of the tidal power dams are connected to each other by putting a connection structure therebetween.

23. The complex ocean power system according to claim 19, wherein at least one or more sluice structures of the tidal power dams are connected to each other, respectively.

24. The complex ocean power system according to claim 19, wherein the barrages have an elliptical shape or a curved shape to induce seawater in the ocean current power generation parks.

25. The complex ocean power system according to claim 19, wherein the ocean current generators installed in the complex ocean power system have a structure or function, which is able to generate electricity even when the direction of ocean current is changed.

26. A complex ocean power system combining sluice power generation and ocean current power generation, comprising:
constructing barrages, which cross over the sea, to make up a lake;
installing sluice structures of tidal power dams between the barrages to generate electricity by changing a potential energy difference between seawaters caused by tides and ebbs to kinetic energy;
installing ocean current generators within the sluice structures to generate electricity by rotating turbine blades using the flow of the incoming seawater;
installing sluice gates in the sluice structures to close and open sluice conduits during flood tide and ebb tide;
forming an ocean current power park in a sea side by installing a plurality of ocean current generators in a rear lake side of the sluice structures of the tidal power dams to generate electricity using the flow of the seawater discharged through the sluice structures and forming an ocean current power park in the sea side by installing a plurality of ocean current generators in the front sea side of the sluice structures of the tidal power dams to generate electricity using the flow of the seawater with fast speed discharged into the sea side through the sluice gates.

27. The complex ocean power system according to claim 26, wherein the plurality of ocean current generators installed in the rear lake side of the sluice structures of the tidal power dams are arranged in a cross shape with a predetermined space between lines and the ocean current generators in even number line and odd number line are arranged to be cross each other.

28. The complex ocean power system according to claim 26, wherein the plurality of ocean current generators installed in the front sea side of the sluice structures of the tidal power dams are arranged in cross shape with a predetermined space between lines and the ocean current generators in even number line and odd number line are arranged to be cross each other.

29. The complex ocean power system according to claim 26, wherein the plurality of ocean current generators installed in the rear lake side of the turbine structures of the tidal power dams are installed at a monofile inserted into the sea bed, respectively.

30. The complex ocean power system according to claim 26, wherein the plurality of ocean current generators installed in the front sea side of the sluice structures of the tidal power dam are installed at a monofile inserted into the sea bed, respectively.

31. The complex ocean power system according to claim 26, wherein the sluice structures of the tidal power dams are connected to each other by putting a connection structure therebetween.

32. The complex ocean power system according to claim 26, wherein at least one or more sluice structures of the tidal power dams are connected to each other, respectively.

33. The complex ocean power system according to claim 26, wherein the barrages have an elliptical shape or a curved shape to induce seawater in the ocean current power generation parks.

34. The complex ocean power system according to claim 26, wherein the ocean current generators installed in the complex ocean power system have a structure or function, which is able to generate electricity even when the direction of ocean current is changed.
